(19) United States
(12) Patent Application Publication
(10) Pub. No.: US 2010/0162589 A1
(43) Pub. Date: Jul. 1, 2010

(54) METHOD FOR PROCESSING AND DRYING WASTE IN A CONTINUOUS PROCESS

(76) Inventor: Gedalyahu Manor, Haifa (IL)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/452,653

(22) PCT Filed: Jul. 21, 2008
(86) PCT No.: PCT/US2008/008842

§ 371 Date: Jan. 13, 2010

Related U.S. Application Data
(60) Provisional application No. 60/961,159, filed on Jul. 19, 2007.

(51) Int. Cl. F26B 15/10

(52) U.S. Cl. 34/427; 34/90

(57) ABSTRACT

A method of drying waste in a continuous process comprising feeding waste into a waste receiving means, continually moving said waste from said waste receiving means to a waste discharge means. The waste is heated and aerated as it is moved from said receiving means to said discharge means. Said feed wet waste is substantially dry when it is at said waste discharge means. A continuous waste drying system comprising: accepting and feeding means for wet waste; continuous-flow conveying system for the waste; aerating and drying means for the waste; heating means of the drying air and the waste, and sensing and control system for optimum drying operation.

### BACKGROUND OF THE INVENTION

The present invention relates to a method and devices for processing and drying moist organic waste. Organic wastes are moist sludge separated from sewage, moist organic matter separated from municipal garbage and moist manure from animal growing facilities. The organic wastes are wet, in most cases, have undesired smell and pollute the ground and ground water by leached water from them. The wastes have nutrients good for agricultural crops and can save fertilizers as well as being used as energy source. The organic wastes need some biochemical and/or drying process to be able to being spread in agricultural fields, which is the preferred use of them, or being used as an energy source.

Several manufacturers are drying sludge under transparent cover in batches, using rotary machines, powered by vehicles, to break the crust on the surface and aerate the surface of the sludge with the aid of fans to enhance the drying process.

It is an object of the invention to provide a method and devices for chemical processing and/or drying the waste in a continuous process, while using mainly solar energy for heating the waste and the air being used to take the vapors away. In order to dry the waste quickly, the contact area of the waste with the drying air is enlarged by cutting lumps of waste and throwing them up to the flowing air by rotary tillers, which is different from the known methods on the market. Another possibility to enlarge the contact area is by pressing air through the waste from holes in the floor or other surfaces in contact like a dragging blade. The biochemical processing by adding materials to the waste can be done at any point along the drying process. The dry waste coming out of the process will be ready for being spread in agricultural fields without polluting the soil or water, but saving fertilizers, or being used as energy source.

### SUMMARY OF THE INVENTION

The invention provides a method for processing and or drying organic wastes in a continuous process, while using mainly solar energy, direct or indirect, and large surface area of waste in contact with the drying air for the process. The surface area is enlarged by cutting lumps and throwing them up in the drying air by rotary tillers, and/or pressing air through the waste from holes in the floor or other surfaces in contact. The wastes to be processed may be moist sludge from sewage treating facilities, moist organic municipal garbage or moist animal's manure. The process starts with heaps of wet waste being dumped from trucks on to a slow moving feeder. The biochemical process, if needed, takes place at this point or at the end of the drying process. At the end of the feeder a rotary pulverizer-feeder feeds the drying area with a continuous flow of wet waste.

In a preferred embodiment the aerating means and continuous flow of waste are rotary tillers, which pulverize the waste and throw lumps up into the drying air and directing it to fall backward to its place, while moving forward or forward in the moving direction, while moving back, until the dry waste reaches the unloading pit.

In a preferred embodiment the rotary tillers are powered by electric motors on them, connected to the electric source by stretched cables.

In another preferred embodiment the rotary tillers are powered by electric motors on them, connected to the electric source by cables rolled on a reel.

In another preferred embodiment the rotary tillers are powered by hydraulic motors on them, connected to the hydraulic pump by hoses rolled on a reel.

In another preferred embodiment the rotary tillers are powered by hydraulic motors on them, connected to the hydraulic pump by stretched hoses.

In another preferred embodiment the rotary tillers are powered by electric motor via drugging chains and sprockets engaged to linear gear-rods at the side walls.

In another preferred embodiment the rotary tillers are powered by electric motor via drugging chains and road wheels and gear boxes

In another preferred embodiment the rotary tillers are powered by internal combustion engine.

In another preferred embodiment the continuous flow of waste is performed by a dragging conveyor which pulls the waste from the feeding point along the drying chamber in relation to the tillers. The waste is being aerated and heated while being moved along the drying chamber. The dried waste, at the end of the dragging conveyor, enters a pit with loading facilities.

In another preferred embodiment the continuous flow of waste is performed by a rotary tiller throwing lumps of waste upward and forward and being moved by powered wheels.

In another preferred embodiment the continuous flow of waste is performed by a vibrating conveyor with floating air jets coming out of the floor. The floating air jets, which move through the sludge, are used also for the aerating and drying process by using the large area of contact.

The heating preferred embodiment is a transparent cover over the whole system, using the solar energy to heat the waste directly or in combination of air solar-heaters.

In another preferred embodiment the heating system is a floor with imbedded pipes in which hot water are flowing through.

In another preferred embodiment the aerating means are dry air jets flowing out of the dragging blades or from the floor under the conveyor.

In another preferred embodiment the aerating means are fans for circulating the air above the waste and through the moving and flowing lumps of waste.

The drying process is preferred to be controlled by a computerized control system, using sensors to measure the different parameters like the flow-rate of the waste by laser sensors, the temperatures of the waste, the air, the floor etc. by infra red cameras at different points. Measuring the energy usage by monitoring the electricity usage. Monitoring the water content of the waste at different points by measuring the moisture of samples. Sensors to measure the number of revolutions of the tillers, the forward or backward velocity of the tillers and any other parameter as needed. The measured data is transferred to the main computer by cables or wire-less communication. The system can be automatically or manually controlled by a remote computer which collects the processed data from the main computer and presenting it in tables and graphs. The system will be able to control the flow rate of the waste and the function of all the systems affecting the results of the drying process, like the number of revolutions of the tiller, the linear velocity of it, the flow rate of the feeder and the operation of the air fans. The control system will alarm in different ways for any undesired results in the drying process.

### BRIEF DESCRIPTION OF THE DRAWINGS

FIG. 1 is a side cross section of a waste drying system.

FIG. 2 is a side view of a waste dragging blade with pulverizing and aerating means.

FIG. 3 is a side cross section of a vibrating conveyor with air jets from holes in its bottom for aerating and drying the waste.

FIG. 4 is a schematic drawing of a cross section of a waste drying system with solar energy collectors and fans for air circulation.

FIG. 5 is a schematic drawing of powering the pulverizing rotary tiller by way of a gearbox and a sprocket engaged to a side mounted linear gear-rod.

FIG. 6 is a schematic drawing of powering the pulverizing rotary tiller by way of a road wheel and a gearbox.

FIG. 7 is a schematic drawing of a cross section of a rotary tiller with directing covers and a sweeping soft blade.

FIG. 8 is a simplified block diagram of a control system.

### DETAILED DESCRIPTION

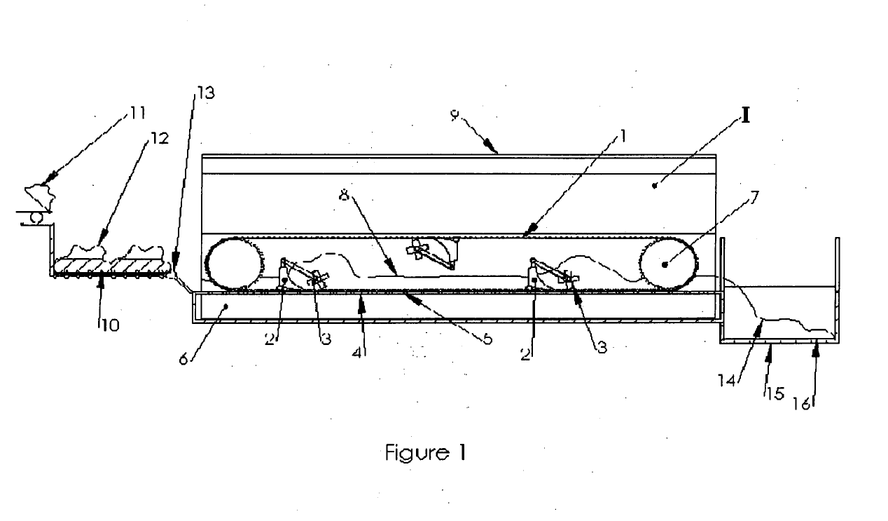

FIG. 1 is a side cross section of a waste drying system I with a dragging chain 1 pulling a dragging blade 2 and a rotary tiller 3. The dragging system is moving over a floor 4 having water heating pipes 4a (not shown here) and/or holes 5 and over a space 6, where from dry and hot air is pushed through the holes 5 to heat and/or aerate and dry the waste 8 being dragged by the dragging blade 2 and rotary-tiller 3. The dragging chain 1 is powered by a motor by means of a large sprocket 7. The drying space over the dragged waste 8 is covered by a transparent cover 9, which lets the solar energy to heat the waste and isolate the space from the outside weather. The feeding conveyor 10 is collecting waste from a dump-truck 11 as heaps 12. The heaps 12 are being moved slowly for biochemistry process to take place. The heaps of waste 12 are pulverized and fed to the drying system I by a rotary pulverizer-feeder 13. At the end of the drying process, the dried waste 14 is falling to the collecting pit 15. The collecting pit can be used for biochemistry process as well. The conveyor-elevator 16 is loading vehicles to move the dry waste 14 to its last destination.

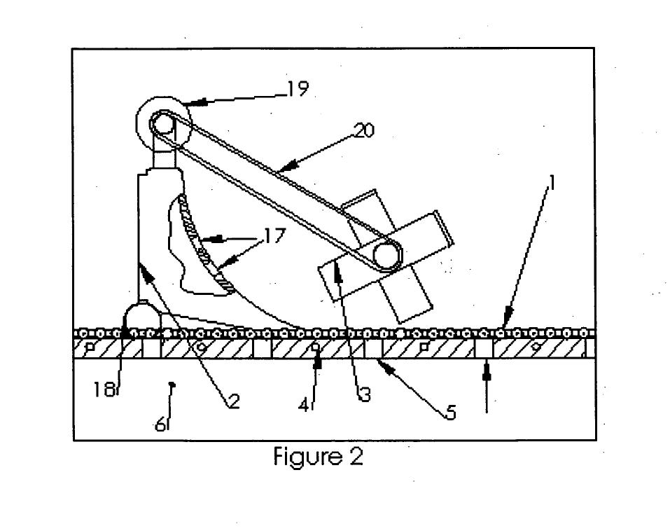

FIG. 2 is a side view of a waste dragging blade 2 with a rotary tiller 3 at its front and a depth control wheels 18 at its back. The dragging blade 2 has holes 17 through which air jets are being forced out to help drying the waste 8 (not shown here) at its front. The rotary tiller 3 is powered by the motor 19 via the chain 20.

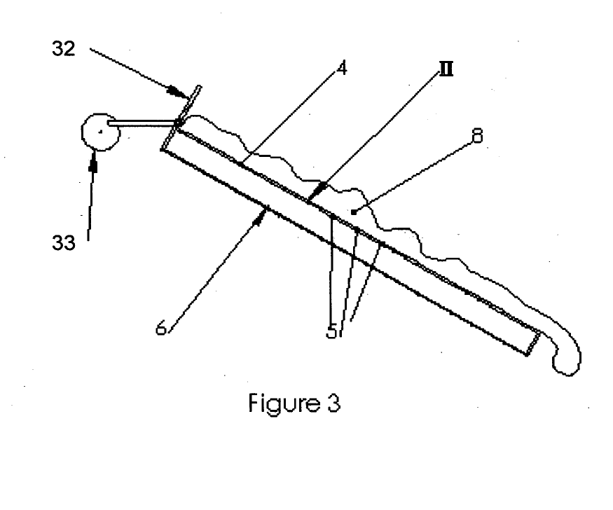

FIG. 3 is a side view of a vibrating conveyor II with air jets from holes 5 in its bottom 4 for aerating and drying the waste 8. The air jets are forced from the space 6 through the holes 5. The wet waste 8 is fed at the front wall 32 moves along the vibrating conveyor by the drying air jets and the vibrations, and discharged at the other end as dried waste. The eccentric wheel 33 is vibrating the conveyor.

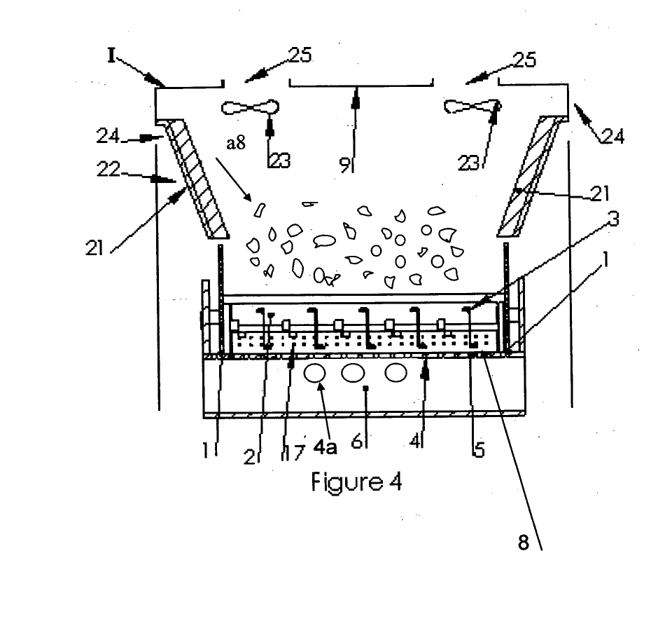

FIG. 4 is a schematic drawing of a cross section of a waste drying system I with solar energy collectors 21 to heat and dry the air 22 circulated by the fans 23. The ambient air is entering the transparent cover 9 through holes 24, heated by the heat collectors 21 and pushed down to the flowing waste lumps 8a. The air jets coming through the holes 5 in the floor 4 helps to dry the waste 8. The floor 4 is heated by the hot water flowing in the pipes 4a and heats the waste 8. The rotary tiller 3 pulverizes the waste 8 and throws it up for better contact with the hot and dry air 22, circulated by the fans 23. The wet air is pumped out by the fans 23 through the holes 25 in the transparent cover 9 and cleaned later. The heat collectors 21 may be electric solar cells.

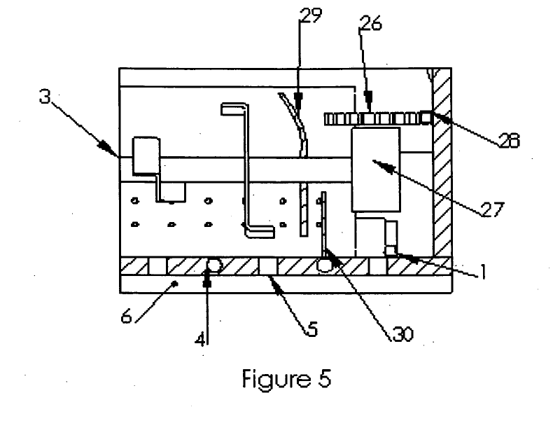

FIG. 5 is a schematic drawing of powering the pulverizing rotary tiller 3 by way of a sprocket 26 via gearbox 27. The sprocket 26 is engaged to a linear gear-rod 28 at the side wall. As the dragging chain 1 pulls the rotary tiller 3, the sprocket 26 rotates and rotates the rotary tiller 3 via the gearbox 27. The sprocket 26 is separated from the waste 8 by the guard 29 at the side of the rotary tiller 3. The dragging chain 1 is separated from the waste 8 by the wall 30.

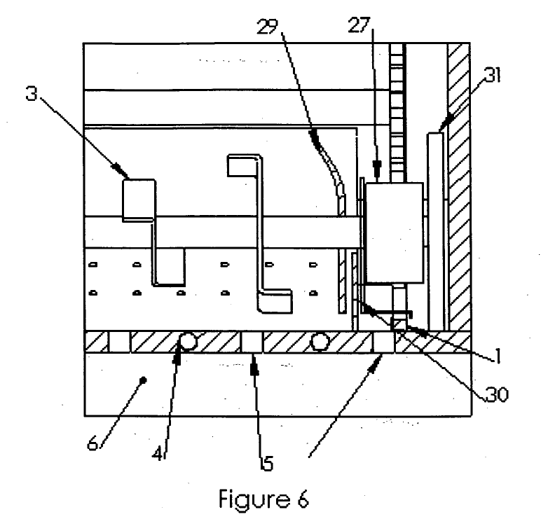

FIG. 6 is a schematic drawing of powering the pulverizing rotary tiller 3 by way of a road wheel 31 and gear box 27.

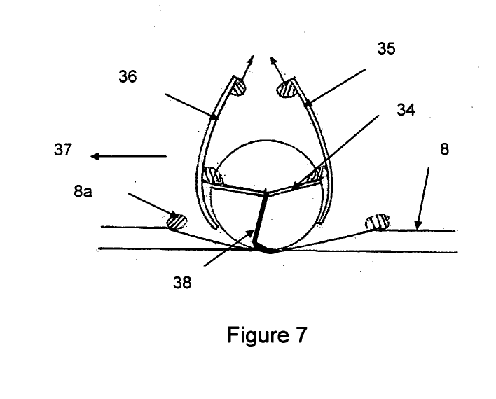

FIG. 7 is a schematic drawing of a cross section of a rotary tiller with directing covers 35 and 36 and a sweeping soft blade 38. When the tiller moves forward, to the left side of the drawing in arrow 37, the blades 34 rotate clock-wise, cut the waste 8 and throw the lumps 8a up, directed by the left cover 36 and let them fall at the back of the tiller. When the tiller moves backwards, to the right side of the drawing, the blades 34 rotate anti-clock-wise, cut the waste 8 and throw the lumps 8a up, directed by the right cover 35 and let them fall forwarding the direction of the arrow 37 and forward as a continuous process.

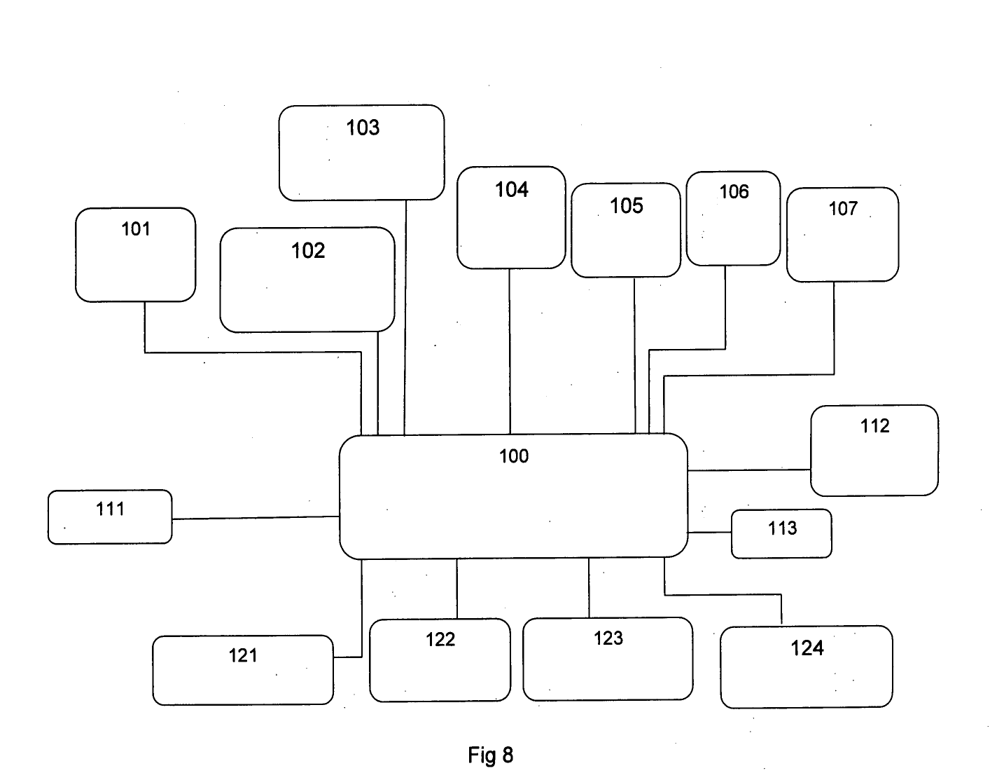

FIG. 8 is a simplified block diagram of a control system. The main control computer 100 is collecting data from the measuring instruments: The waste flow rate sensor 101, The IR cameras 102 for measuring the temperature of the waste, The air thermometers 103, The energy usage monitor 104, The moisture meters 105, The RPM of the rotary tiller 106, and the linear velocity of the rotary tiller 107. The main control computer 100 is processing the collected data and presents the results on monitor 112, or starts an alarm 113 in case of emergency. Manual device 111 enables the possibility of introducing commands or data to the main control computer in order to change the control process if needed. The main control computer 100 uses the results of the control process to send commands: to the rotating motor of the tiller 3 for the number of revolutions 121, to the moving motor of the tiller 3 for the forward velocity 122, to the motor of the feeder 13 for the flow rate of the waste 123, to the fans 23 for the air flow rate 124, and to any other device to be controlled.

1. A method of drying waste in a continuous process comprising feeding wet waste into a waste receiving means, continuously moving said waste from said waste receiving means to a waste discharge means, heating and aerating said waste as it is moved from said receiving means to said discharge means whereby said wet waste is substantially dry when it is at said waste discharge means.

2. The method of claim 1, wherein the waste is sewage sludge.

3. The method of claim 1, wherein the waste is organic municipal garbage.

4. The method of claim 1, wherein the waste is animal manure.

5. The method of claim 1 wherein continuously moving said waste from said waste receiving means to the waste discharge means by using a feeding system.

6. The method of claim 5, wherein the feeding system is conveying system using a dragging blade on a floor.

7. The method of claim 5, wherein the feeding system is conveying system using at least one lump throwing rotary tiller on a floor with at least one circle of cutting and throwing blades.

8. The method of claim 1, wherein aerating said waste using an aerating system, said aerating system is using a rotary tiller on a floor with at least one circle of cutting and throwing blades to pulverize the waste and throw its lumps with large surface area upward and forward into the air in order to dry it and move it.

9. The method of claim 1, wherein aerating said waste using an aerating system, said aerating system is using air jets flowing out of holes in front of a dragging blade on a floor.

10. The method of claim 1, wherein aerating said waste using an aerating and drying systems, said aerating system is using circulating air being moved by fans over the waste and through the thrown lumps of claim 7 and holes in the floors.

11. The method of claim 1, wherein aerating said waste using solar energy which penetrates a transparent cover over the waste, heating the waste and heating solar air heaters.

12. The method of claim 11, wherein said solar in heaters are electric solar cells.

13. The method of claim 1, wherein wet waste is fed to a waste receiving means by a feeding conveyor and a rotary pulverizer-feeder.

14. The method of claim 1, wherein said waste discharge means is a pit with a conveyer-elevator for loading handling machines.

15. The method of claim 1, further comprising a controlling and optimizing system, said system is using sensors to measure the parameters affecting the process and one or more computers to control the process automatically or manually, and an alarm in case of emergency.

16. A continuous waste drying arrangement comprising:
accepting and feeding means for wet waste;
continuous-flow conveying system for the waste;
aerating and drying means for the waste;
heating means to dry air and the waste;
collecting and conveying means for dried waste; and
sensing and control system for optimum drying operation.

17. The continuous waste drying arrangement of claim 16 wherein the accepting means for wet waste is a feeding conveyor and a rotary pulverizer-feeder.

18. The continuous waste drying arrangement of claim 16 wherein the continuous-flow conveying system is using a dragging blade.

19. The continuous waste drying arrangement of claim 16 wherein the continuous-flow conveying system is using at least one rotary tiller with at least one circle of rotating blades to aerate the waste by cutting it and throwing its lumps upward and forward.

20. The continuous waste drying arrangement of claim 18 wherein powered wheels move the dragging blade and the at least one rotary tiller.

21. The continuous waste drying arrangement of claim 18 wherein the dragging blade having holes at its front to flow air and aerate the waste being dragged by it.

22. The continuous waste drying arrangement of claim 19 wherein the at least one rotary tiller being powered by a motor.

23. The continuous waste drying arrangement of claim 16 wherein the aerating means are air jets flowing through holes in the floor under the waste.

24. The continuous waste drying arrangement of claim 16 wherein the aerating and drying system is using circulating air being moved by fans over the waste and through the upward thrown lumps.

25. The continuous waste drying arrangement of claim 16, wherein the heating system is using solar energy penetrating a transparent cover, and heating the air and/or water by solar energy collectors and the waste.

26. The continuous waste drying arrangement of claim 16, wherein the sensing and control system comprises sensors to measure parameters affecting the process, a computer to collect data from the sensors, to analyze it and control the parameters of the continuous-flow system and the heating means and optionally to alarm if there is an emergency.
